(19) United States
(12) Patent Application Publication
(10) Pub. No.: US 2012/0049392 A1
(43) Pub. Date: Mar. 1, 2012

(54) Structured Packing with Extended Contact Area

(76) Inventor: Carlos Jose Trompiz, Deer Park, TX (US)

(21) Appl. No.: 12/868,226

(22) Filed: Aug. 25, 2010

(51) Int. Cl. B01F 3/04

(52) U.S. Cl. 261/112.2

(57) ABSTRACT

A structured packing for vapor-liquid mass or heat transfer is disclosed in the form of a plurality of corrugated sheets comprising primary corrugations and secondary corrugations which significantly increase the contact area provided by the structured packing for the vapor-liquid mass or heat transfer.

### BACKGROUND OF THE INVENTION

The present invention relates to chemical, petrochemical or oil refining process equipment in which vapor or gas is contacted with liquid. This vapor-liquid contact may be used just for heat transfer between the two phases (vapor and liquid) or for mass transfer where components from the vapor are transferred to the liquid and components from the liquid are transferred to the vapor.

The invention is specifically related to the structured packing used for counter-current vapor-liquid flow within a tower or column where mass or heat transfer between the vapor and liquid is required. The primary design objective of the structured packing in the tower is to provide ample opportunity for the vapor and liquid flowing in counter-current through the tower to come into intimate and extended contact with each other so that the required mass or heat exchange between the vapor and liquid may take place.

The mass or heat transfer between the vapor and liquid is strongly dependent on the area of contact provided by the structured packing for a good intimate contact between the vapor and liquid. The typical structured packing used in towers for vapor and liquid contact is formed of a plurality of corrugated sheets of one or another kind of material and arranged generally parallel to the axis of the tower in which the structured packing is installed. Depending on the specific structured packing type, the corrugations in the sheets have all the same dimensions (crimp height, crimp width, and angle of the corrugation ridge respect to the column axis) and the sheets may be provided with surface texture treatment and holes or openings to improve the vapor and liquid spread and distribution across the packing sheets. The corrugations are arranged at angles respect to the tower axis so that the corrugations of adjacent sheets criss-cross. This arrangement avoids the need of using spacers or other devices to separate the sheets from each other. Since the corrugations have the same dimensions for a specific structured packing, the criss-crossing ridges maintain the sheets at the same distance from each other and keep the sheets in the desired position when they are wrapped with binding material or otherwise bound.

Since the distance between adjacent sheets depends on the dimensions of the corrugations specifically the crimp height, the smaller the crimp height, the smaller the distance between sheets and therefore the larger number of sheets that can be installed in a specific tower diameter. The larger number of packing sheets, the greater the contact area provided for the vapor-liquid contact and the higher and better the packing efficiency for mass or heat transfer between the vapor and liquid. On the other hand, the larger number of packing sheets, the shorter the distance and smaller the spacing and cross sectional area between the sheets, and the higher the packing pressure drop and therefore the lower the packing capacity to handle the vapor and liquid flow rates for a specific tower diameter.

In general, based on the typical configuration of the corrugated sheets in the structured packing, when the contact area is increased by using a structured packing with a smaller crimp height to increase and improve the packing efficiency for vapor-liquid mass or heat transfer, the packing capacity is reduced due to the higher pressure drop which would require a bigger diameter tower to handle the specific vapor and liquid flow rates. Conversely, if a structured packing with a larger crimp height is used to increase the spacing and cross sectional area between the sheets, the packing capacity is increased and larger vapor and liquid flow rates can be handled by the packing for a specific tower diameter, however, the contact area and the packing efficiency for mass or heat transfer is reduced and a taller packing section and a taller tower will be required to meet the mass or heat transfer requirements between the vapor and liquid.

The present invention provides a new design of structured packing which increases the contact area and improves the structured packing performance in towers used for vapor-liquid mass or heat transfer.

### GENERAL DESCRIPTION OF THE INVENTION

The present invention relates to an improved structured packing of the corrugated sheet-type in which the corrugation angles are such that the corrugation of adjacent sheets criss-cross and wherein the sheets may be provided with a surface texture treatment and holes or openings. The corrugated sheets are kept at a specific distance depending on the corrugation or crimp height. However, instead of corrugated sheets with a single type of corrugations as provided by the prior art, the present invention provides corrugated sheets with two corrugation types: Primary corrugations which have the same function as the corrugations found in the prior art structured packings; and secondary corrugations with a smaller size and running in parallel to the primary corrugations and located on the area of the sheets between the ridges of the primary corrugations. These secondary corrugations provide the structured packing according to the invention with a significant additional contact area for mass or heat transfer between the vapor and liquid while keeping the same spacing and cross sectional area between the corrugated sheets compared to the prior art structured packing. The increase in the vapor-liquid contact area provided by the secondary corrugations represents an increase of the structured packing efficiency for mass or heat transfer between the vapor and liquid. Since the secondary corrugations do not change the spacing and cross sectional area between the corrugated sheets of the structured packing, the packing pressure drop is practically not affected compared to the prior art structured packings. Therefore, the structured packing according to the invention is able to provide a higher mass or heat transfer efficiency between the vapor and liquid at the same capacity compared to the prior art structured packing.

### DRAWINGS

FIG. 1 is a representation of two consecutive corrugated sheets in a structured packing according to the prior art. The surface texture and holes that may be present on the corrugated sheets are omitted for clarity.

FIG. 2 is a side view of a section of a corrugated sheet in the prior art structured packing as seen from the arrows shown in FIG. 1.

FIG. 3 is the equivalent view of FIG. 2 but showing the corrugated sheet of the structured packing according to the invention.

FIG. 4 is the equivalent view of FIG. 3 of the corrugation sheet of the structured packing according to the invention showing a variation by using rounded corrugations.

### DETAILED DESCRIPTION OF THE INVENTION

The invention is now further described with reference to the Drawings which are intended to illustrate the invention but not to be understood as implying any essential limitations on the scope of the invention.

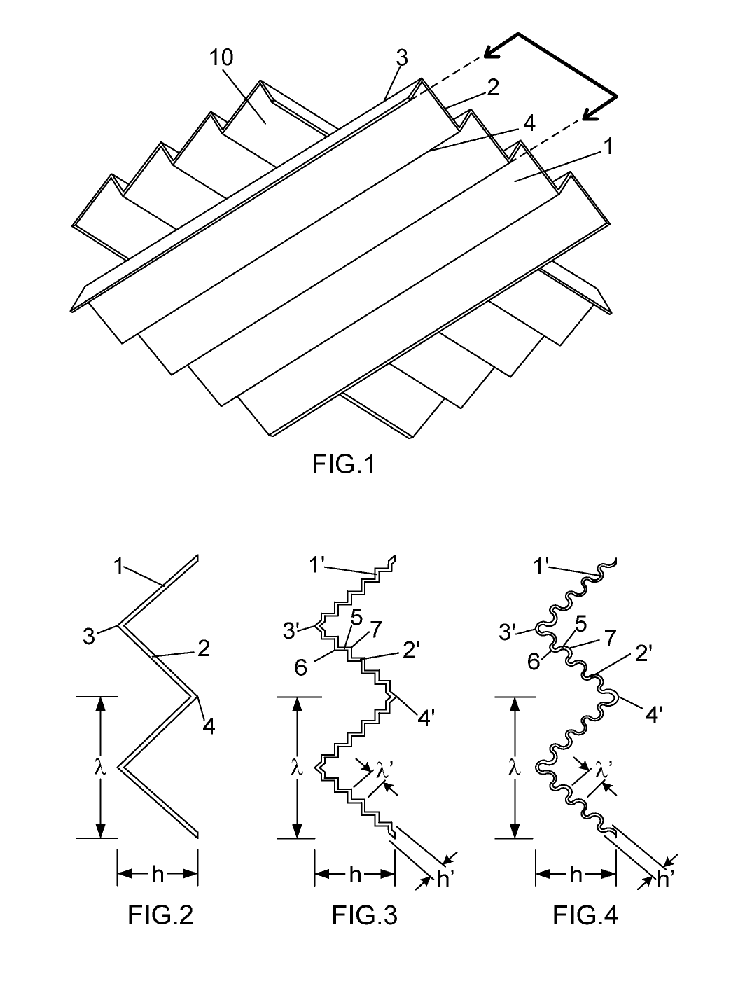

FIG. 1 shows a section of a couple of adjacent corrugated sheets, 1 and 10 in the prior art structured packing with corrugations, 2, and corrugation ridges, 3 and 4. As shown in FIG. 2, the corrugations, 2, of the sheets in the prior art structured packing have all the same dimensions, with a corrugation or crimp height, h, and corrugation length or crimp width, λ.

FIG. 3 shows the corrugated sheet configuration in the structured packing according to the invention. In addition to the corrugations, 2′, or primary corrugations with corrugation ridges 3′ and 4′, and with crimp height, h, and crimp width, λ, there are secondary corrugations, 5. These secondary corrugations, 5, have corrugations ridges, 6 and 7, with crimp height, h′, and crimp width, λ′. In general, the secondary corrugations are smaller than the primary corrugations, thus λ′<λ, and h′<h, as shown in FIG. 3.

FIG. 4 shows a variation of the corrugated sheet configuration in the structured packing according to the invention with rounded primary and secondary corrugations but with the same characteristics as described above for FIG. 3. Any combination of straight and rounded corrugations can be used for primary and secondary corrugations.

What is claimed is:

1. A structured packing for vapor-liquid contact inside a tower comprising a plurality of corrugated sheets arranged in parallel to each other, wherein at least one of said corrugated sheets is provided with at least one secondary corrugation between two consecutive ridges of at least one of the primary corrugations.

2. A structured packing according to claim 1, wherein the secondary corrugation configuration at the ridge is straight forming a V-shaped ridge.

3. A structured packing according to claim 1, wherein the secondary corrugation configuration is rounded.

4. A structured packing according to claim 1, wherein the primary corrugation configuration at the ridge is straight forming a V-shaped ridge.

5. A structured packing according to claim 1, wherein the primary corrugation configuration at the ridge is rounded.

6. A structured packing according to claim 1, wherein the corrugated sheets have holes or openings.

7. A structured packing according to claim 1, wherein the corrugated sheets have surface texture treatment.

8. A structured packing according to claim 1, wherein the angle of the corrugations respect to the tower axis is reduced at the top of the corrugated sheets.

9. A structured packing according to claim 1, wherein the angle of the corrugations respect to the tower axis is reduced at the bottom of the corrugated sheets.

10. A structured packing according to claim 1, wherein at least one flat sheet without corrugations is positioned along with the corrugated sheets.

11. A structured packing according to claim 1, wherein spacers are positioned in between consecutive sheets.

12. A structured packing according to claim 1, wherein stiffeners are positioned along with the corrugated sheets.

13. A structured packing according to claim 1, wherein corrugated gauze-type material is used instead of corrugated sheets.
